(19) United States
(12) Patent Application Publication
(10) Pub. No.: US 2026/0150154 A1
(43) Pub. Date: May 28, 2026

(54) METHODS FOR IDENTIFYING AND PRIORITIZING EMERGENCY CALLBACKS

(71) Applicant: T-Mobile Innovations LLC, Overland Park, KS (US)

(72) Inventors: Manikanta Kumar Teja PENUMATSHA, Redmond, WA (US); Jenniffer Lucas CRUZ, Renton, WA (US); Sudhanshu PANDEY, Sammamish, WA (US); Niranjan PIRATLA, Renton, WA (US)

(21) Appl. No.: 18/962,058

(22) Filed: Nov. 27, 2024

(51) Int. Cl. H04W 76/50; H04L 65/1016; H04L 65/1104

(52) U.S. Cl. CPC H04W 76/50; H04L 65/1016; H04L 65/1104

(57) ABSTRACT

Methods are provided for initiating an emergency call session between a public safety access point (PSAP) and a wireless device, receiving from the PSAP a session initiation protocol (SIP) signaling message containing an emergency callback number, and updating a recognized call number list of the wireless device to identify the emergency callback number as a recognized emergency number.

### TECHNICAL BACKGROUND

Cellular phones, such as smartphones, are often used for contacting emergency services. In some instances, the emergency service is contactable by a public safety answering point (PSAP). In some instances, after the initial emergency call session is terminated, a call may be made from an emergency number to the cellular phone. This call may be from the PSAP or may be from a particular emergency service and may be made to obtain further information or to provide updates to the caller. However, the user of the cellular phone may decline the follow-up call due to not recognizing the number as belonging to emergency services, resulting in delayed contact between the emergency service and the caller.

### OVERVIEW

Exemplary embodiments described herein include methods for identifying and prioritizing emergency callbacks. An exemplary method includes initiating an emergency call session between a PSAP and a wireless device. Once the emergency call session is initiated, the method includes receiving from the PSAP a situation initiation protocol (SIP) update. The SIP signaling message contains an emergency callback number. The method then further includes updating a recognized call number list of the wireless device to identify the emergency callback number as a recognized emergency number.

Another example method includes initiating an emergency call session between a wireless device and a PSAP. The method further receiving from the PSAP a SIP signaling message containing an emergency callback number. Upon receiving the SIP signaling message, the method includes updating a recognized call number list of the wireless device, where updating the recognized call number list comprises identifying the emergency callback number as a recognized emergency number. The method then includes ending the emergency call session. Once the emergency call session has ended, the method includes receiving a call from the emergency callback number. The method then further includes identifying, at the wireless device, the emergency callback number as a recognized emergency number in response to receiving the call.

A further example method identifying and prioritizing an emergency callback includes initiating an emergency call session between a public safety access point (PSAP) and a wireless device. The method then includes receiving a SIP signaling message containing a first emergency callback number from the PSAP. Once the SIP signaling message has bene received, the method includes updating a recognized call number list of the wireless device. Updating the recognized call number list includes identifying the first emergency callback number as a recognized emergency number. The method then includes ending the emergency call session. The method further includes receiving, at the wireless device, an updated SIP signaling message, with the updated SIP signaling message containing a second emergency callback number.

### BRIEF DESCRIPTION OF THE DRAWINGS

FIG. 1 illustrates an exemplary system for wireless device communication in accordance with disclosed embodiments.

FIG. 2 illustrates an additional exemplary system for wireless device communication with a PSAP in accordance with disclosed embodiments.

FIG. 3 illustrates an example method for identifying and prioritizing emergency callbacks in accordance with disclosed embodiments.

FIG. 4 illustrates another example method for identifying and prioritizing emergency callbacks in accordance with disclosed embodiments.

FIG. 5 illustrates another example method for identifying and prioritizing emergency callbacks in accordance with disclosed embodiments.

### DETAILED DESCRIPTION

When an emergency call, such as a call to 911, is made, a public safety access point (PSAP) receives the call. The PSAP is connected to a variety of emergency services, such as police, fire, and emergency medical service (EMS), and as such, the PSAP is able to coordinate aid to the caller based on information collected during the emergency call.

In some instances, after the initial call is completed, the PSAP or a particular emergency service may need to initiate a callback to the caller. However, the telephone number that is displayed on the wireless device is not 911 but is a traditional long-code telephone number due to 911 being a short code number. A short code number refers to a shortened telephone number, commonly between three and six digits, that can be used in lieu of a ten-digit long code. As a result, the caller may decline to answer the callback, particularly if the caller erroneously determines that the unrecognized number is either a robocall or spam call.

Exemplary embodiments described herein include methods for identifying and prioritizing emergency callbacks. For example, during an emergency call between a wireless device and a PSAP, the PSAP operator may determine which emergency service or services are most likely to be appropriate for response to the caller. The PSAP operator has access to a system that includes telephone numbers for various emergency responders and emergency services. Once the PSAP operator determines which emergency service(s) are appropriate, the PSAP operator may transmit a message to the wireless device that includes the corresponding telephone number(s). The message may indicate that the transmitted number(s) are for emergency service. Once the wireless device receives the message, the wireless device can update its recognized call number list to tag the telephone number(s) received in the message as belonging to an emergency service. Thus, when the wireless device receives a callback, the wireless device will display an indication that the telephone number is associated with an emergency service and should be prioritized for answering by the user.

In addition, update messages may be transmitted if, for example, changes in emergency responder occur. Receiving such update messages allows the wireless device to re-update its recognized call number list. This facilitates efficient communication between the caller and the emergency responder, as well as increasing the likelihood that the callback number will display as belonging to an emergency service, thus increasing the likelihood that the caller will answer the callback.

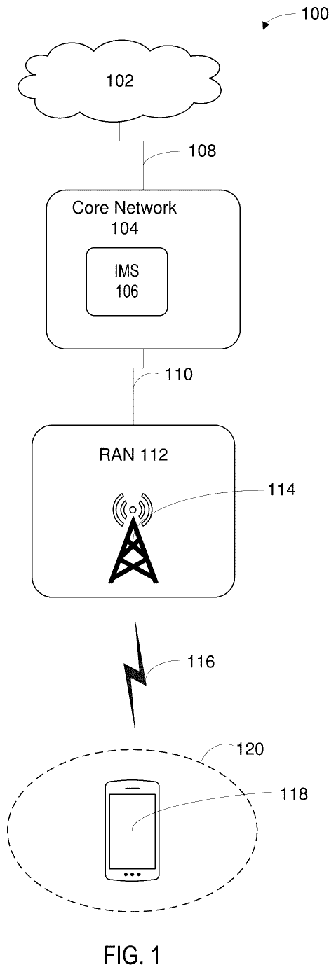

These and other examples will be described in greater detail below in relation to FIGS. 1-5.

FIG. 1 depicts an exemplary system 100 for wireless communication. System 100 includes a communication network 102, a core network 104 and a radio access network (RAN) 112, including at least one access node 114. The RAN 112 may include other devices and additional access nodes. Although one access node is shown, any number of access nodes may be included.

System 100 also includes a wireless device 118, which may be an end-user wireless device and may operate within a coverage area 120. The wireless device 118 may communicate with an access node 114 within the RAN 112 over a communication link 116.

Communication network 102 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 102 can be capable of carrying data, for example, to support voice, push-to-talk, broadcast video, and data communications by wireless device 118. Wireless network protocols can comprise Fifth Generation mobile networks or wireless systems (4G or 4G LTE) or 5G. Wired network protocols that may be utilized by communication network 102 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 102 can also comprise additional base stations, controller nodes, telephony switches, internet routers, network gateways, computer systems, communication links, or some other type of communication equipment, and combinations thereof.

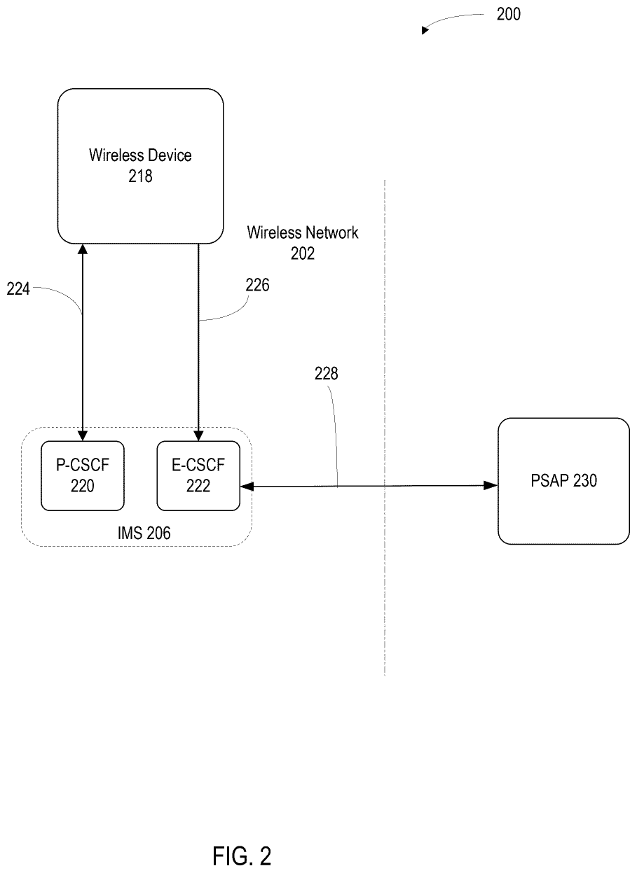

The core network 104 includes the IP Multimedia Subsystem (IMS) 106, which will be explained further in relation to FIG. 2. The core network 104 may be separated into user plane functions and control plane functions. The user plane accesses a data network, such as network 102, and performs operations such as packet routing and forwarding, packet inspection, policy enforcement for the user plane, quality of service (QoS) handling, etc. The control plane handles radio-specific functionality that depends on the idle or connected states of the wireless device 118.

Core network 104 may include an IP multimedia subsystem (IMS) 106. IMS 106 as used herein is a framework used for delivering IP multimedia services, such as voice over internet protocol (VoIP) and/or other similar services, across a network. IMS 106 may include a call session control function (CSCF). The CSCF as used herein is a component of IMS 106 used for session control, signaling and routing in multimedia communication. In embodiments, the CSCF may be used for handling session initiation protocol (SIP) communication. In embodiments, IMS 103 may be used for communication between entities or components of network 102 and wireless device 118. For example, the CSCF of the IMS 106 may be used for transmitting SIP communication to wireless device 118 and a PSAP. Communication links 108 and 110 can use various communication media, such as air, space, metal, optical fiber, or some other signal propagation path-including combinations thereof. Communication links 108 and 110 can be wired or wireless and use various communication protocols such as Internet, Internet protocol (IP), local-area network (LAN), S1, optical networking, hybrid fiber coax (HFC), telephony, T1, or some other communication format—including combinations, improvements, or variations thereof. Wireless communication links may use electromagnetic waves in the radio frequency (RF), microwave, infrared (IR), or other wavelength ranges, and may use a suitable communication protocol, including 4G including 4G NR or 4G Advanced, 6G, NTN, or combinations thereof.

Communication links 108 and 110 can be direct links or might include various equipment, intermediate components, systems, and networks, such as a cell site router, etc. Communication links 108 and 110 may comprise many different signals sharing the same link.

The RAN 112 may include an access network system and device such as access node 114. The RAN 112 is disposed between the core network 104 and the end-user wireless device 118. Components of the RAN 112 may communicate directly with the core network 104 and others may communicate directly with the end user wireless device 118. The RAN 112 may provide services from the core network 104 to the end-user wireless device 118.

The RAN 112 includes an access node (or base station) 114, which may include one or more access nodes communicating with the end-user wireless device 118. It should be understood that the disclosed technology may also be applied to communication between an end-user wireless device and other network resources, such as relay nodes, controller nodes, antennas, etc. The RAN 112 may further comprise a non-terrestrial network (NTN) serving the multiple UEs by a radio frequency transmission provided by utilizing orbiting satellites that may be in communication with access nodes of a terrestrial network (TN). The satellites may include geosynchronous equatorial orbit (GEO) satellites, Medium Earth Orbit (MEO) satellites, and low Earth orbit (LEO) satellites. The NTN may include NTN nodes that are not stationed on the ground.

Access node 114 can be, for example, standard access nodes such as a macro-cell access node, a base transceiver station, a radio base station, an evolved NodeB (or eNodeB) in 4G or 4G LTE, a next generation NodeB (or gNodeB) in 5G New Radio (“5G NR”), or the like. In additional embodiments, access nodes may comprise two co-located cells, or antenna/transceiver combinations that are mounted on the same structure. Alternatively, access node 114 may comprise a short range, low power, small-cell access node such as a microcell access node, a picocell access node, a femtocell access node. Access node 114 can be configured to deploy one or more different carriers, utilizing one or more RATs. Any other combination of access nodes and carriers deployed therefrom may be evident to those having ordinary skill in the art in light of this disclosure.

The access node 114 and servers in the IMS 105 may comprise a processor and associated circuitry to execute or direct the execution of computer-readable instructions. They may retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

The wireless device 118 may include any wireless device included in a wireless network. Wireless device 118 may include any device configured to send and receive messages over SIP. For example, the term “wireless device” may include a relay node, which may communicate with an access node. The term “wireless device” may also include an end-user wireless device, which may communicate with the access node through a relay node. The term “wireless device” may further include an end-user wireless device that communicates with the access node directly without being relayed by a relay node. Wireless device 118 may be any device, system, combination of devices, or other such communication platform capable of communicating wirelessly with access node 114 using one or more frequency bands and wireless carriers deployed therefrom. Wireless device 118 may be, for example, a mobile phone, a wireless phone, a wireless modem, a personal digital assistant (PDA), a voice over internet protocol (VoIP) phone, a voice over packet (VOP) phone, or a soft phone, a wearable device, an internet of things (IoT) device, as well as other types of devices or systems that can send and receive audio or data. The wireless device 118 may be or include high power wireless devices or standard power wireless devices.

System 100 may further include many components not specifically shown in FIG. 1 including processing nodes, controller nodes, routers, gateways, and physical and/or wireless data links for communicating signals among various network elements. System 100 may include one or more of a local area network, a wide area network, and an internetwork (including the Internet). Communication system 100 may be capable of communicating signals and carrying data, for example, to support voice, push-to-talk, broadcast video, and data communications by end-user wireless device 118.

Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g., between the radio access network 112 and the core network 104.

Although one core network 104 is shown, multiple core networks 104 may be utilized. Alternatively, the single core network 104 may include a distributed, cloud-native, converged core gateway. Thus, the converged core gateway could connect a 4G LTE evolved packet core (EPC) to a 5G core network.

Communication links 108 and 110 can use various communication media, such as air, space, metal, optical fiber, or some other signal propagation path, including combinations thereof. Communication links 108 and 110 can be wired or wireless and use various communication protocols such as Internet, Internet protocol (IP), local-area network (LAN), S1, optical networking, hybrid fiber coax (HFC), telephony, T1, or some other communication format—including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, 6G or combinations thereof. Other wireless protocols can also be used. Communication links 108 and 110 can be direct links or might include various equipment, intermediate components, systems, and networks, such as a cell site router, etc. Communication links 108 and 110 may comprise many different signals sharing the same link.

The methods, systems, devices, networks, access nodes, and equipment described herein may be implemented with, contain, or be executed by one or more computer systems and/or processing nodes. The methods described above may also be stored on a non-transitory computer readable medium. Many of the elements of system 100 may be, comprise, or include computers systems and/or processing nodes, including access nodes, controller nodes, and gateway nodes described herein.

The operations for identifying emergency callback numbers may be implemented as computer-readable instructions or methods, and processing nodes on the network and/or computing device, such as end user wireless device, for executing the instructions or methods. The processing node may include a processor included in the access node or a processor included in any controller node in the wireless network that is coupled to the access node. The computing device may include at least a processor and a memory with instructions configuring the processor to execute instructions.

Now referring to FIG. 2, an exemplary system 200 for identifying and prioritizing emergency callbacks using SIP is presented. System 200 includes a wireless device 218. Wireless device 218 may be the same as wireless device 118. System 200 also includes wireless network 202. Wireless network 202 may include a RAN, core network and/or a communication network, which may be the same as, respectively, RAN 112, core network 104 and communication network 102. In some examples, wireless network 202 may be hosted by a mobile network operator (MNO).

The IMS 206 includes may include servers, including a proxy call session control function (P-CSCF) 220 and an emergency call session control function {E-CSCF) 222, shown, but it should be understood that there are many other types of IMS and core servers that are omitted for clarity. A proxy server, such as P-CSCF 220 receives a call request from a wireless device, as shown by arrow 224. Headers may be added to the call request in the form of SIP headers such as Resource Priority Header (RPH), X-MAV-RPH:911, Orig. ID, and Attestation-Info. The call request may then be forwarded to an emergency call management server such as E-CSCF 222 for further processing, as shown by arrow 226. E-CSCF 222 may query a gateway mobile location center (GMLC) for information about the destination network of the call. The GMLC returns information on a public safety access point (PSAP) 230 that services the location of the wireless device that originated the call request. This information includes how to contact the PSAP 230. The wireless device 218 is then connected to the PSAP 230. PSAP 230 may use SIP trunking to connect to IMS 206, which allows PSAP 230 to send and receive voice and multimedia data over an IP network, as shown by arrow 228. PSAP 230 may use SIP and session description protocol (SDP) for managing session and session parameters.

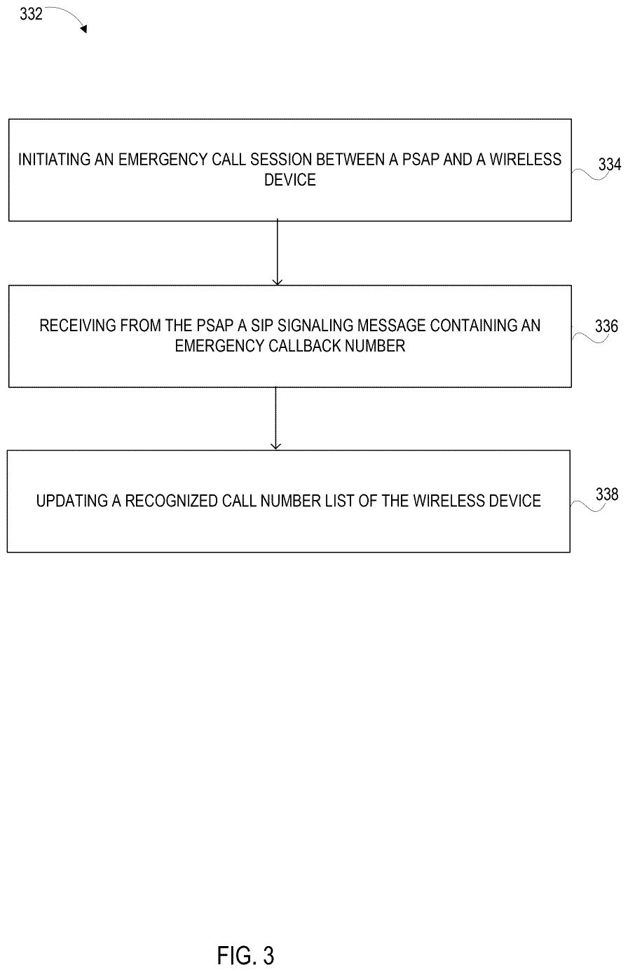

FIG. 3 illustrates an example method 332 for identifying and prioritizing emergency callbacks in accordance with disclosed embodiments. Method 332 may be performed by any suitable combination of processors discussed herein, for example a processor contained in an emergency call management server, such as an E-CSCF server.

Method 332 begins in step 334 where an emergency call session is initiated between a PSAP and a wireless device. The emergency call session may be transmitted via a wireless network, which may be hosted by a mobile network operation (MNO). In some examples, the emergency call is a session initiation protocol (SIP) invite. In embodiments, the CSCF transmits an SIP INVITE from the wireless device 218 to the PSAP 230 or vice versa. In embodiments, the SIP INVITE may include session description protocol (SDP) parameters that establishes an IMS DC for the session.

Method 332 continues in step 336 where the wireless device receives, from the PSAP, a SIP signaling message, such as a SIP UPDATE, SIP MESSAGE, OR SIP NOTIFY containing an emergency callback number. The SIP signaling message is transmitted using an IMS DC. An IMS DC refers to a content-agnostic data transmission tunnel that uses SIP and IP Multimedia Subsystem (IMS) to carry multimedia services over an IP network. In an embodiment, the SIP signaling message may be transmitted by the PSAP 230 to wireless device 218. In some examples, the PSAP may transmit a SIP signaling message that includes SDP with parameters establishing the IMS DC and subsequently may transmit the emergency callback number using the IMS DC. The header of the SIP signaling message may include the emergency callback number. Once the wireless device receives the SIP signaling message, the wireless device may extract the emergency callback number from the header.

At step 338, method 332 includes updating a recognized call number list of the wireless device. As used herein, a recognized call number list refers to a database of telephone numbers that are identified by a caller identification system such that when a number on the list calls a wireless device, the name or business associated with the incoming call is displayed. More particularly, the recognized call number list may be updated to identify the emergency callback number received in the SIP signaling message at step 336 as a recognized emergency number. By adding the emergency callback number to the recognized call number list, if and when a callback occurs, the wireless device is able to display that the number is an emergency number.

Method 332 may further include using the wireless device to transmit a confirmation of receipt of the SIP signaling message and update of the recognized call number list. In some examples, the confirmation of receipt may be a 200 OK message transmitted from the wireless device to the PSAP. Once the PSAP receives the confirmation, the PSAP confirms that the SIP signaling message has been successful. However, if the wireless device does not send a confirmation of receipt within a predetermined period of time, the PSAP may send a SIP NOTIFY to the wireless device. The SIP NOTIFY is used to confirm that the wireless device did receive the SIP signaling message and performed the update to the recognized call numbers. In examples where the PSAP sends a SIP NOTIFY, the wireless device may send a confirmation message to the PSAP in response to receipt of the SIP NOTIFY.

Method 332 may further include receiving a call from the emergency callback number. This call may occur after the emergency call session initiated at step 334 has ended. Because the emergency callback number was added to the wireless device's recognized call number list at step 338, the wireless device identifies the emergency callback number as a recognized emergency number. As a result, the wireless device displays identification such as “emergency call” or “emergency number” together with displaying the emergency callback number to the user, thus informing the user of the origin of the call and increasing the likelihood of the user answering the call.

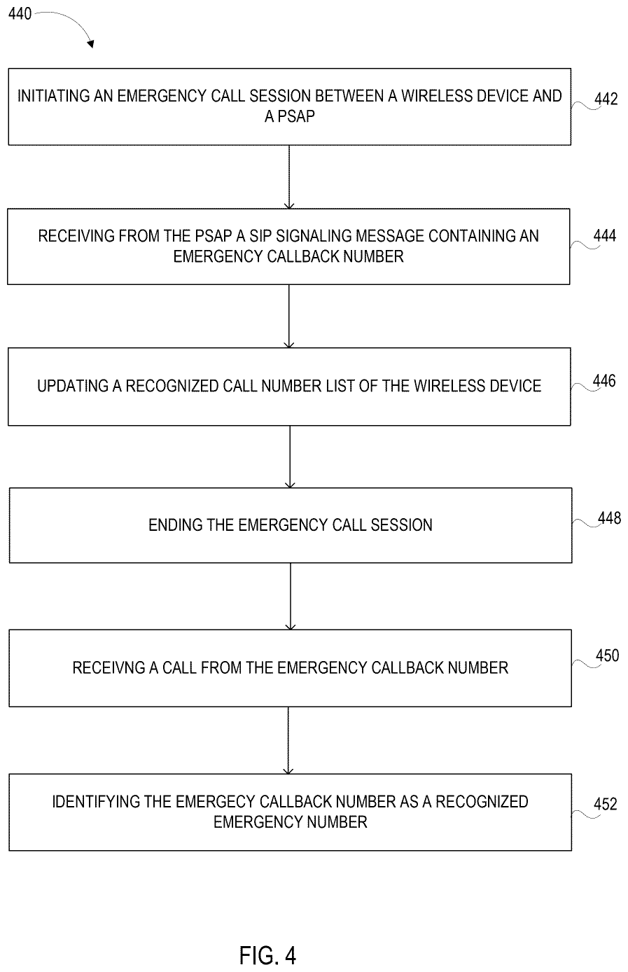

FIG. 4 illustrates another example method 440 for identifying and prioritizing emergency callbacks in accordance with disclosed embodiments. Method 440 may be performed by any suitable combination of processors discussed herein, for example a processor contained in an emergency call management server, such as an E-CSCF server.

Method 440 begins at step 442 where an emergency call session is initiated between a PSAP and a wireless device. The emergency call session may be transmitted via a wireless network, which may be hosted by a mobile network operation (MNO). In some examples, the emergency call is a session initiation protocol (SIP) invite. In embodiments, the CSCF transmits an SIP INVITE from the wireless device 218 to the PSAP 230 or vice versa. In embodiments, the SIP INVITE may include session description protocol (SDP) parameters that establishes an IMS DC for the session.

Method 440 continues in step 444 where the wireless device receives, from the PSAP, a SIP signaling message containing an emergency callback number. The SIP signaling message is transmitted using an IMS DC. In some examples, the PSAP may transmit a SIP signaling message that includes SDP with parameters establishing the IMS DC and subsequently may transmit the emergency callback number using the IMS DC. The header of the SIP signaling message may include the emergency callback number. Once the wireless device receives the SIP signaling message, the wireless device may extract the emergency callback number from the header.

In some examples, the SIP signaling message may include at least two emergency callback numbers. For example, the SIP signaling message may include a callback number for police and a callback number for the fire department, although examples are not so limited. The particular callback numbers that are included in the SIP signaling message are determined by the PSAP operator and may correspond to the services that, based on the PSAP operator's discussion with the user, are most likely to be required based on the nature of the emergency. In examples where at least two emergency callback numbers are included in the SIP signaling message, the header of the SIP signaling message includes the emergency callback numbers.

At step 446, method 440 includes updating a recognized call number list of the wireless device to include the emergency callback number received in the SIP signaling message at step 442 as a recognized emergency number. As described with respect to FIG. 3, adding the emergency callback number to the recognized call number list of the wireless device will allow the wireless device to display the number as an emergency call when a call is received from the emergency callback number.

In some examples, method 440 may further include using the wireless device to transmit a confirmation of receipt of the SIP signaling message and update of the recognized call number list. In some examples, the confirmation of receipt may be a 200 OK message transmitted from the wireless device to the PSAP. Once the PSAP receives the confirmation, the PSAP confirms that the SIP signaling message has been successful and that the emergency callback number has been added to the recognized call number list.

Method 440 continues in step 448 with ending the emergency call session. The emergency call session may be ended either at the PSAP by the PSAP operator or by the user of the wireless device.

At step 450, method 440 includes receiving a call from the emergency callback number. The call may be received at the wireless device and may be transmitted via a wireless network. In some examples, the call from the emergency callback number may be received after the emergency call session has ended in 448.

Method 440 continues at 452 with identifying, at the wireless device, the emergency callback number as a recognized emergency number. The identification of the emergency callback number as a recognized emergency number may occur in response to receiving a call from the emergency callback number at step 450. Because the emergency callback number was added to the recognized call number list at step 446, when the call is received at the wireless device, the wireless device displays the emergency callback number as well as an identifier that the callback number is coming from an emergency service.

Method 440 may further include receiving an updated SIP signaling message from the PSAP at the wireless device. The updated SIP signaling message may be received after the emergency call ends at step 448 and may contain at least one additional emergency callback number. For example, the initial SIP signaling message may include a number connected to fire service and the updated SIP signaling message may include a number connected to police; however, examples are not so limited. As with the initial SIP signaling message, the updated SIP signaling message may be received at the wireless device by an IMS DC. Once the wireless device receives the updated SIP signaling message, the wireless device updates its recognized call number list to include the at least one additional emergency callback number.

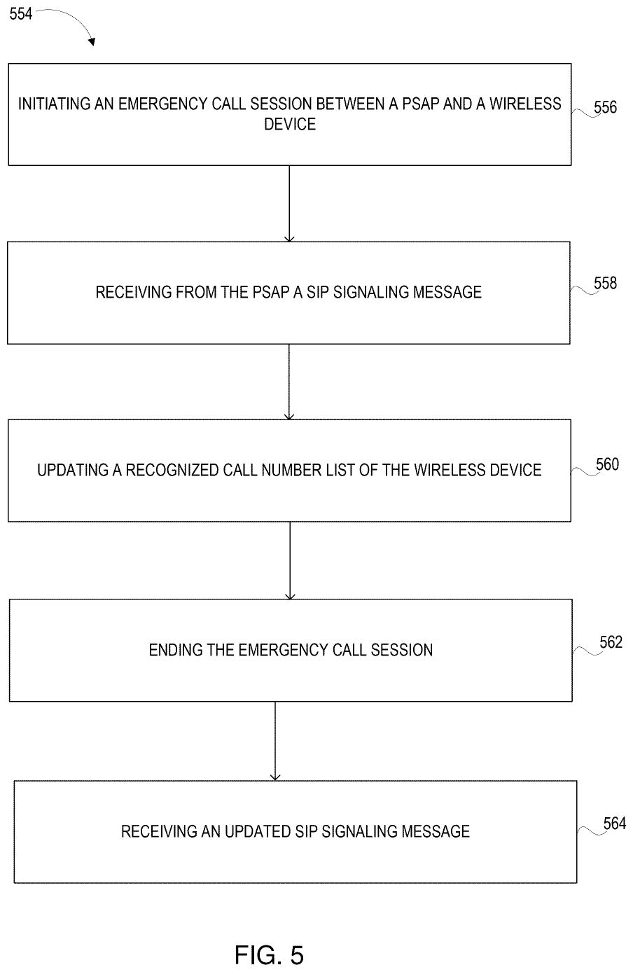

FIG. 5 illustrates another example method 554 for identifying and prioritizing emergency callbacks in accordance with disclosed embodiments. Method 554 may be performed by any suitable combination of processors discussed herein, for example a processor contained in an emergency call management server, such as an E-CSCF server.

Method 554 begins in step 556 by initiating an emergency call session between a PSAP and a wireless device. The emergency call session may be transmitted via a wireless network, which may be hosted by a mobile network operation (MNO). In some examples, the emergency call is in a session initiation protocol (SIP) invite. In embodiments, the CSCF transmits an SIP INVITE from the wireless device 218 to the PSAP 230 or vice versa. In some examples, the SIP INVITE includes session description protocol (SDP) parameters which establish an IMS DC for the session.

At step 558, method 554 includes receiving, at the wireless device, a SIP signaling message from the PSAP. The SIP signaling message includes a first emergency callback number. In some examples, the first emergency callback number corresponds to a first emergency service. The PSAP may transmit a SIP signaling message that includes SDP with parameters establishing the IMS DC and may subsequently transmit the first emergency callback number using the IMS DC. The SIP signaling message includes a header, and the header may contain the first emergency callback number. The wireless device may extract the first emergency callback number from the header upon receiving the SIP signaling message.

Method 554 continues at step 560 with updating a recognized call number list of the wireless device. More particularly, step 560 may include updating the recognized call number list of the wireless device to add the first emergency callback number to the recognized call number list. Once the first emergency callback number is added to the recognized call number list, the wireless device can display the number as an emergency call when a call is received from the first emergency callback number.

In response to updating the recognized call number list at step 560, method 554 may include using the wireless device to transmit confirmation that the SIP signaling message was received at the wireless device and that the wireless device updated the recognized call number list with the first emergency callback number. In some examples, the confirmation may be a 200 OK message transmitted form the wireless device to the PSAP, although examples are not so limited and other confirmation formats may be used.

At step 562, method 554 includes ending the emergency call session. The emergency call session may be ended by the PSAP operator or by the user of the wireless device.

Method 554 continues in step 564 with receiving an updated SIP signaling message. The updated SIP signaling message includes a second emergency callback number, with the second emergency callback number being different than the first emergency callback number. As with the initial SIP signaling message, the updated SIP signaling message may be received at the wireless device via an IMS DC. The second emergency callback number may be contained within the header of the updated SIP signaling message. Upon receiving the updated SIP signaling message and extracting the second emergency callback number, the wireless device may update its recognized call number list to include the second emergency callback number. More particularly, the wireless device may update its recognized call number list to identify the second emergency callback number as a recognized emergency number.

Method 554 may further include receiving a call from one of the first and second emergency callback numbers. The call may be received after the emergency call session is ended at step 562. In some examples, the call may be received at the wireless device and may be transmitted via a wireless network. In response to receiving the call, the wireless device may identify the number transmitting the call as one of the first and second emergency callback numbers. More particularly, the number may be identified as one of the first and second emergency callback numbers based on the recognized call number list, as the first and second emergency callback numbers were added to the list at steps 560 and 564, respectively. As such, the wireless device is able to display the status of the call as coming from an emergency number, thus increasing the likelihood that the user will answer the call.

In some embodiments, methods 332, 440 and 554 may include additional steps or operations. Furthermore, the methods may include steps shown in each of the other methods. As one of ordinary skill in the art would understand, the methods of 332, 440 and 554 may be integrated in any useful manner and the steps may be performed in any useful sequence.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices. Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not all be within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method, comprising:
initiating an emergency call session between a public safety access point (PSAP) and a wireless device;
receiving from the PSAP a session initiation protocol (SIP) signaling message containing an emergency callback number; and
updating a recognized call number list of the wireless device to identify the emergency callback number as a recognized emergency number.

2. The method of claim 1, further comprising receiving a call from the emergency callback number after the emergency call session has ended.

3. The method of claim 2, further comprising responsive to receiving the call, identifying at the wireless device the emergency callback number as a recognized emergency number.

4. The method of claim 1, further comprising transmitting, by the wireless device, a confirmation of receipt of the SIP signaling message.

5. The method of claim 1, wherein a header of the SIP signaling message contains the emergency callback number.

6. The method of claim 1, wherein the SIP signaling message is received via an IP multimedia subsystem data channel (IMS DC).

7. A method, comprising:
initiating an emergency call session between a wireless device and a public safety access point (PSAP);
receiving from the PSAP a session initiation protocol (SIP) signaling message containing an emergency callback number;
updating a recognized call number list of the wireless device to identify the emergency callback number as a recognized emergency number;
ending the emergency call session;
receiving a call from the emergency callback number after the emergency call session has ended; and
responsive to receiving the call, identifying at the wireless device the emergency callback number as a recognized emergency number.

8. The method of claim 7, further comprising:
receiving, at the wireless device, an updated SIP signaling message from the PSAP; and
updating the recognized call number list of the wireless device based on the updated SIP signaling message.

9. The method of claim 8, wherein the updated SIP signaling message contains at least one additional emergency callback number.

10. The method of claim 7, wherein a header of the SIP signaling message contains the emergency callback number.

11. The method of claim 7, wherein the SIP signaling message includes at least two emergency callback numbers.

12. The method of claim 7, wherein the SIP signaling message is received via an IP multimedia subsystem data channel (IMS DC).

13. The method of claim 7, further comprising, responsive to receiving from the PSAP a SIP signaling message, transmitting an acknowledgement of the SIP signaling message from the wireless device to the PSAP.

14. The method of claim 13, wherein transmitting an acknowledgement of the SIP signaling message further comprises sending a 200 OK response to the PSAP by SIP.

15. A method, comprising:
initiating an emergency call session between a public safety access point (PSAP) and a wireless device;
receiving from the PSAP a session initiation protocol (SIP) signaling message containing a first emergency callback number;
updating a recognized call number list of the wireless device to identify the first emergency callback number as a recognized emergency number;
ending the emergency call session; and
receiving, at the wireless device, an updated SIP signaling message containing a second emergency callback number.

16. The method of claim 15, further comprising updating the recognized call number list of the wireless device to identify the second emergency callback number as a recognized emergency number.

17. The method of claim 15, further comprising:
receiving, after the wireless device has disconnected from the emergency call session, at the wireless device, a call from one of the first and second emergency callback numbers; and
responsive to receiving the call, identifying at the wireless device the one of the first and second emergency callback numbers as a recognized emergency number.

18. The method of claim 15, wherein the SIP signaling message is received via an IP multimedia subsystem data channel (IMS DC).

19. The method of claim 15, wherein a header of the SIP signaling message contains the first emergency callback number.

20. The method of claim 15, wherein a header of the updated SIP signaling message contains the second emergency callback number.
